(19) United States
(12) Patent Application Publication
(10) Pub. No.: US 2021/0153286 A1
(43) Pub. Date: May 20, 2021

(54) METHOD FOR CONTROLLING PROTOCOL DATA UNIT SESSION IN WIRELESS COMMUNICATION SYSTEM, AND APPARATUS FOR SAME

(71) Applicant: LG ELECTRONICS INC., Seoul (KR)

(72) Inventors: Sangmin PARK, Seoul (KR); Jaehyun KIM, Seoul (KR); Hyunsook KIM, Seoul (KR); Jinsook RYU, Seoul (KR); Myungjune YOUN, Seoul (KR)

(73) Assignee: LG Electronics Inc., Soul (KR)

(21) Appl. No.: 17/043,777

(22) PCT Filed: Mar. 28, 2019
(86) PCT No.: PCT/KR2019/003661

§ 371 Date: Sep. 30, 2020

Related U.S. Application Data
(60) Provisional application No. 62/652,916, filed on Apr. 5, 2018.

(51) Int. Cl. H04W 76/22

(52) U.S. Cl. CPC H04W 76/22

(57) ABSTRACT

A method for controlling a protocol data unit (PDU) session and a device therefor in a wireless communication system are disclosed. More specifically, a method for a session management function (SMF) to control a PDU session for low latency service in the wireless communication system includes receiving a request message related to the PDU session from a user equipment (UE), determining whether the request message related to the PDU session is a request for low latency service, and sending the UE a response message for the request message related to the PDU session based on the request message related to the PDU session including the request for low latency service, the response message including low latency information for a PDU session related to the request message related to the PDU session.

### TECHNICAL FIELD

The present disclosure relates to a wireless communication system, and more particularly to a method capable of efficiently serving a service requiring ultra reliable and low latency communication (URLLC) feature, and a device supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive multiple input multiple output (MIMO), in-band full duplex, non-orthogonal multiple access (NOMA), supporting a super-wide band, and device networking, have been researched.

### DISCLOSURE

### Technical Problem

The present disclosure provides a method of providing a service requiring ultra reliable and low latency communication (URLLC) feature in a wireless communication system.

The present disclosure provides a method of controlling a protocol data unit (PDU) session for low latency service.

The technical problems of the present disclosure are not limited to the aforementioned technical problems, and other technical problems which are not mentioned above will be apparently appreciated by a person having ordinary skill in the art from the following description.

### Technical Solution

In one aspect, there is provided a method for a session management function (SMF) to control a protocol data unit (PDU) session for a low latency service in a wireless communication system, the method comprising receiving, from a user equipment (UE), a request message related to the PDU session, determining whether the request message related to the PDU session is a request for the low latency service, and sending the UE a response message for the request message related to the PDU session based on the request message related to the PDU session including the request for the low latency service, the response message including low latency information for a PDU session related to the request message related to the PDU session.

In another aspect, there is provided a session management function (SMF) device for controlling a protocol data unit (PDU) session for a low latency service in a wireless communication system, the SMF device comprising a transceiver configured to transmit and receive a radio signal, and a processor configured to control the transceiver, wherein the processor is further configured to receive a request message related to the PDU session from a user equipment (UE), determine whether the request message related to the PDU session is a request for the low latency service, and send the UE a response message for the request message related to the PDU session based on the request message related to the PDU session including the request for the low latency service, the response message including low latency information for a PDU session related to the request message related to the PDU session.

It may be determined whether the request message related to the PDU session is the request for the low latency service based on a fifth generation (5G) quality of service (QoS) identifier (5QI), a data network name (DNN), single network slice selection assistance information (S-NSSAI), or an indication that requests the PDU session for the low latency service, that are included in the request message related to the PDU session.

It may be determined whether the request message related to the PDU session is the request for the low latency service by checking a policy through a communication with a policy control function (PCF) or checking subscriber information of the UE through a communication with a unified data management (UDM).

The request message related to the PDU session may be a PDU session establishment request or a PDU session modification request.

The response message may be a PDU session establishment accept message or a PDU session modification command message.

Low latency information may be stored in a PDU session context for the PDU session related to the request message related to the PDU session.

The PDU session for the low latency service may include an always-on PDU session or a low latency PDU session.

The PDU session for the low latency service may be a PDU session in which a user plane connection for the PDU session for the low latency service is maintained while the UE is in a connected mode after the user plane connection for the PDU session for the low latency service is activated.

### Advantageous Effects

Embodiments of the present disclosure can efficiently provide a service requiring ultra reliable and low latency communication (URLLC) feature in a wireless communication system.

Embodiments of the present disclosure can efficiently control a protocol data unit (PDU) session for low latency service.

Advantages which can be obtained in the present disclosure are not limited to the aforementioned effects and other unmentioned advantages will be clearly understood by those skilled in the art from the following description.

### DESCRIPTION OF DRAWINGS

The accompanying drawings, that are included to provide a further understanding of the present disclosure and are incorporated in and constitute a part of the present disclosure, illustrate embodiments of the present disclosure and together with the description serve to explain various principles of the present disclosure.

FIG. 1 illustrates a wireless communication system architecture to which the present disclosure is applicable.

FIG. 2 illustrates a radio protocol stack in a wireless communication system to which the present disclosure is applicable.

FIG. 3 illustrates an uplink data status information element in a wireless communication system to which the present disclosure is applicable.

FIG. 4 illustrates a 5GMM sublayer state of a UE in a wireless communication system to which the present disclosure is applicable.

FIG. 5 illustrates a 5GMM sublayer state of a network in a wireless communication system to which the present disclosure is applicable.

FIG. 6 illustrates a method of controlling a PDU session for low latency service according to an embodiment of the present disclosure.

FIG. 7 illustrates a method of controlling a PDU session for low latency service according to an embodiment of the present disclosure.

FIG. 8 illustrates a method of controlling a PDU session for low latency service according to an embodiment of the present disclosure.

FIG. 9 illustrates a block configuration diagram of a communication device according to an embodiment of the present disclosure.

FIG. 10 illustrates a block configuration diagram of a communication device according to an embodiment of the present disclosure.

### MODE FOR INVENTION

In what follows, preferred embodiments according to the present disclosure will be described in detail with reference to appended drawings. The detailed descriptions provided below together with appended drawings are intended only to explain illustrative embodiments of the present disclosure, which should not be regarded as the sole embodiments of the present disclosure. The detailed descriptions below include specific information to provide complete understanding of the present disclosure. However, those skilled in the art will be able to comprehend that the present disclosure can be embodied without the specific information.

For some cases, to avoid obscuring the technical principles of the present disclosure, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present disclosure, and the specific terms can be used in different ways as long as it does not leave the technical scope of the present disclosure.

Embodiments of the present disclosure can be supported by standard documents disclosed in at least one of wireless access systems including the IEEE 802, 3GPP, and 3GPP2 specifications. In other words, among the embodiments of the present disclosure, those steps or parts omitted for the purpose of clearly describing technical principles of the present disclosure can be supported by the documents above. Also, all of the terms disclosed in this document can be explained with reference to the standard documents.

To clarify the descriptions, this document is based on the 3GPP 5G (5 Generation) system, but the technical features of the present disclosure are not limited to the current descriptions.

Terms used in this document are defined as follows.

Evolved Packet System (EPS): a network system including an Evolved Packet Core (EPC), that is an Internet Protocol (IP) based packet switched core network, and an access network such as LTE and UTRAN. The EPS is a network of an evolved version of a Universal Mobile Telecommunications System (UMTS).

eNodeB: a base station of an EPS network. The eNodeB is installed outdoor, and its coverage has a scale of a macro cell.

International Mobile Subscriber Identity (IMSI): an internationally unique subscriber identity allocated in a mobile communication network.

Public Land Mobile Network (PLMN): a network configured for the purpose of providing mobile communication services to individuals. The PLMN can be configured for each operator.

5G system (5GS): a system composed of a 5G Access Network (AN), a 5G core network and a User Equipment (UE).

5G Access Network (5G-AN) (or AN): an access network composed of a New Generation Radio Access Network (NG-RAN) and/or a non-3GPP Access Network (AN) connected to the 5G core network.

New Generation Radio Access Network (NG-RAN) (or RAN): a Radio Access Network having a common feature of being connected to 5GC and supporting one or more of the following options:

1) Standalone New Radio.

2) New radio that is an anchor supporting E-UTRA extension.

3) Standalone E-UTRA (for example, eNodeB).

4) Anchor supporting new radio extension

5G Core Network (5GC): a core network connected to a 5G access network.

Network Function (NF): means a processing function adopted in 3GPP within a network or defined in 3GPP. The processing function includes a defined functional behavior and an interface defined in 3GPP.

NF service: a function exposed by the NF via a service-based interface and consumed by other authenticated NF(s).

Network Slice: a logical network that provides specific network capability(s) and network feature(s).

Network Slice instance: a set of NF instance(s) and required resources(s) (e.g., compute, storage, and networking resources) that form a deployed network slice.

Protocol Data Unit (PDU) Connectivity Service: service providing the exchange of PDU(s) between the UE and a data network.

PDU Connectivity Service: service providing the exchange of PDU(s) between the UE and a data network.

PDU Session: association between the UE and the data network providing the PDU Connectivity Service. An association type may be Internet Protocol (IP), Ethernet, or unstructured.

Non-Access Stratum (NAS): a functional layer for transceiving signaling and a traffic message between the UE and the core network in EPS and 5GS protocol stack. The NAS mainly functions to support mobility of the UE and support a session management procedure.

5G System Architecture to which the Present Disclosure is Applicable

A fifth generation (5G) system is a technology evolved from the 4-G LTE mobile communication technology and is the evolution of the existing mobile communication network structure or a new radio access technology (RAT) through a clean-state structure and an extended technology of long term evolution (LTE). The 5G system supports extended LTE (eLTE), non-3GPP (e.g., wireless local access network (WLAN) access, and so on.

A 5G system architecture is defined to support data connections and services so that deployment thereof can use technologies, such as network function virtualization and software-defined networking. In the 5G system architecture, service-based interactions are used between control plane (CP) network functions (NFs).

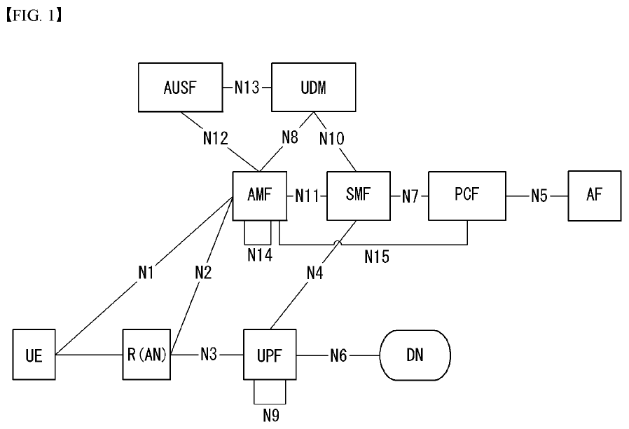

FIG. 1 illustrates a wireless communication system architecture to which the present disclosure is applicable.

The 5G system architecture may include various elements (i.e., network function (NF)). FIG. 1 illustrates elements corresponding to some of the various elements.

An access and mobility management function (AMF) supports functions, such as signaling between CN nodes for mobility between 3GPP access networks, the termination of a radio access network (RAN) CP interface N2, the termination N1 of NAS signaling, registration management (e.g., registration area management), idle mode UE reachability, network slicing, and SMF selection.

Some or all of the functions of the AMF may be supported within one instance of a single AMF.

A data network (DN) means an operator service, Internet access or a 3rd party service, for example. The DN transmits a downlink protocol data unit (PDU) to a user plane function (UPF) or receives a PDU transmitted by a UE.

A policy control function (PCF) provides a function of receiving information on a packet flow from an application server and determining a policy such as mobility management or session management.

A session management function (SMF) provides a session management function and may be managed by a different SMF for each session when a UE has multiple sessions.

Some or all of the functions of the SMF may be supported within one instance of a single SMF.

Unified data management (UDM) stores a user's subscription data, policy data, and so on.

A user plane function (UPF) delivers a downlink PDU, received from a DN, to a UE over a (radio) access network ((R)AN), and delivers an uplink PDU, received from a UE, to a DN over an (R)AN.

An application function (AF) interacts with a 3GPP core network for service provision (e.g., support functions, such as an application influence on traffic routing, network capability exposure access, and an interaction with a policy framework for policy control).

A (radio) access network ((R)AN) collectively refers to a new radio access network that supports both evolved E-UTRA, that is, the evolved version of the 4G radio access technology, and a new radio (NR) (e.g., gNB).

A gNB supports functions for radio resource management (i.e., radio bearer control, radio admission control, connection mobility control, and the dynamic allocation (i.e., scheduling) of resources to a UE in the uplink/downlink).

A user equipment (UE) means a user device.

In the 3GPP system, a conceptual link connecting NFs within the 5G system is defined as a reference point.

N1 (or NG1) means a reference point between a UE and the AMF, N2 (or NG2) means a reference point between the (R)AN and the AMF, N3 (or NG3) means a reference point between the (R)AN and the UPF, N4 (or NG4) means a reference point between the SMF and the UPF, N5 (or NG5) means a reference point between the PCF and the AF, N6 (or NG6) means a reference point between the UPF and the data network, N7 (or NG7) means a reference point between the SMF and the PCF, N24 (or NG24) means a reference point between a PCF within a visited network and a PCF within a home network, N8 (or NG8) means a reference point between the UDM and the AMF, N9 (or NG9) means a reference point between two core UPFs, N10 (or NG10) means a reference point between the UDM and the SMF, N11 (or NG11) means a reference point between the AMF and the SMF, N12 (or NG12) means a reference point between the AMF and the AUSF, N13 (or NG13) means a reference point between the UDM and an authentication server function (AUSF), N14 (or NG14) means a reference point between two AMFs, and N15 (or NG15) means a reference point between the PCF and the AMF in the case of a non-roaming scenario and means a reference point between a PCF within a visited network and the AMF in the case of a roaming scenario.

FIG. 1 illustrates a reference model of a case in which a UE accesses one DN using one PDU session for convenience of explanation, by way of example, but the present disclosure is not limited thereto.

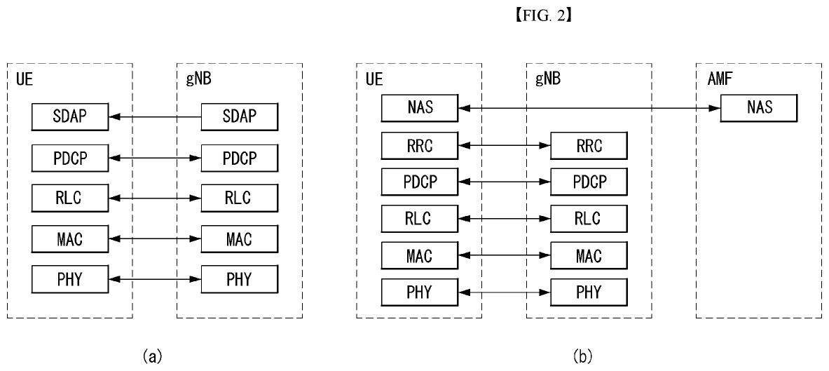

FIG. 2 illustrates a radio protocol stack in a wireless communication system to which the present disclosure is applicable.

FIG. 2(a) illustrates a radio interface user plane protocol stack between a UE and gNB, and FIG. 2(b) illustrates a radio interface control plane protocol stack between the UE and the gNB.

The control plane means a path through which control messages used for a UE and a network to manage calls are transmitted. The user plane means a path through which data generated in an application layer, for example, voice data, Internet packet data, and so on are transmitted.

Referring to FIG. 2(a), the user plane protocol stack may be divided into Layer 1 (i.e., physical (PHY) layer) and Layer 2.

Referring to FIG. 2(b), the control plane protocol stack may be divided into Layer 1 (i.e., PHY layer), Layer 2, Layer 3 (i.e., radio resource control (RRC) layer), and a Non-Access Stratum (NAS) layer.

The Layer 2 is divided into a Medium Access Control (MAC) sublayer, a Radio Link Control (RLC) sublayer, a Packet Data Convergence Protocol (PDCP) sublayer, and a Service Data Adaptation Protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel. The PHY layer is connected to the MAC sublayer located at an upper level through a transport channel, and data are transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC Service Data Unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a Control Channel and a Traffic Channel.

i) The Control Channel is used to deliver only control plane information and is as follows.

Broadcast Control Channel (BCCH): a downlink channel for broadcasting system control information.

Paging Control Channel (PCCH): a downlink channel that delivers paging information and system information change notification.

Common Control Channel (CCCH): a channel for transmitting control information between a UE and a network. This channel is used for UEs having no RRC connection with the network.

Dedicated Control Channel (DCCH): a point-to-point bi-directional channel for transmitting dedicated control information between the UE and the network. This channel is used by the UE having an RRC connection.

ii) The Traffic Channel is used to use only user plane information.

Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a Transparent Mode (TM), an Unacknowledged Mode (UM), and an Acknowledged Mode (AM).

The RLC configuration may be applied for each logical channel. In case of SRB, the TM or the AM is used. On the other hand, in case of DRB, the UM the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs Sequence Numbering; header compression and decompression (Robust Header Compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs Sequence Numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

A single protocol entity of SDAP is configured for each individual PDU session, but exceptionally, in case of dual Connectivity (DC), two SDAP entities can be configured.

6) An RRC sublayer performs broadcast of system information related to Access Stratum (AS) and Non-Access Stratum (NAS); paging initiated by 5GC or NG-RAN; establishment, maintenance and release of RRC connection between UE and NG-RAN (additionally including modification and release of carrier aggregation and also additionally including modification and release of Dual Connectivity between E-UTRAN and NR or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

5G Session Management and Quality of Service (QoS) Model

In the 5G system, requirements for data transmission/reception with low latency and high reliability features were defined. This (particularly, with regard to low latency and high reliability) is described in 3GPP TS 22.261 v15.3.0 as follows.

Various scenarios require the support of very low latency and very high communications service availability. This implies very high reliability. The overall system latency depends on the delay on the radio interface, transmission within the 5G system, transmission to a server which may be outside the 5G system, and data processing. Some of these factors depend directly on the 5G system itself, whereas for others the impact can be reduced by suitable interconnections between the 5G system and services or servers outside the 5G system.

The scenarios requiring the very low latency and very high communications service availability are as follows.

Motion control: Conventional motion control is characterized by high requirements on the communications system regarding latency, reliability, and availability. Systems supporting the motion control are usually deployed in geographically limited areas but may also be deployed in wider areas, access to them may be limited to authorized users. The systems supporting the motion control may be isolated from networks or network resources used by other cellular customers.

Discrete automation: Discrete automation is characterized by high requirements on the communications system regarding reliability and availability. Systems supporting discrete automation are usually deployed in geographically limited areas, and they may be isolated from networks or network resources used by other cellular customers.

Process automation: Automation for flows (e.g., refineries and water distribution networks). Process automation is characterized by high requirements on the communications system regarding communication service availability. Systems supporting process automation are usually deployed in geographically limited areas, access to them is usually limited to authorized users, and it will usually be served by private networks.

Automation for electricity distribution (mainly medium and high voltage): Electricity distribution is characterized by high requirements on the communications service availability. In contrast to the above use cases, electricity distribution is deeply immersed into the public space. Since electricity distribution is an essential infrastructure, it will, as a rule, be served by private networks.

Intelligent transport systems: Automation solutions for the infrastructure supporting street-based traffic. This use case addresses the connection of the road-side infrastructure (e.g., road side units (RSUs)) with other infrastructure (e.g., a traffic guidance system). As is the case for automation electricity, the nodes are deeply immersed into the public space.

Tactile interaction: Tactile interaction is characterized by a human being interacting with the environment or people, or controlling a UE, and relying on tactile feedback.

Remote control: Remote control is characterized by a UE being operated remotely by a human or a computer.

Session Management

The 5GC supports a PDU connectivity service, i.e., a service that provides exchange of PDUs between a UE and a data network identified by a data network name (DNN). The PDU connectivity service is supported via PDU sessions that are established upon request from the UE.

Subscription information may include multiple DNNs and may contain a default DNN. The UE is assigned a default DNN if the UE does not provide a valid DNN in a PDU Session Establishment Request message sent to the network.

Each PDU session supports a single PDU session type. That is, each PDU session supports the exchange of a single type of PDU requested by the UE at the establishment of the PDU session. The following PDU session types are defined: IP version 4 (IPv4), IP version 6 (IPv6), Ethernet, Unstructured.

PDU sessions are established (upon UE request), modified (upon UE or 5GC request), and released (upon UE or 5GC request) using NAS session management (SM) signaling exchanged over N1 between the UE and the SMF. Upon request from an application server, the 5GC is able to trigger a specific application in the UE. When receiving a trigger message, the UE passes the trigger message to the identified application in the UE. The identified application in the UE may establish a PDU session to a specific DNN.

The SMF shall check whether the UE's requests are compliant with the user subscription.

For this purpose, the SMF retrieves and requests to receive update notifications on SMF level subscription data from the UDM. The following data may indicate per DNN and per single network slice selection assistance information (S-NSSAI), if applicable:

The allowed PDU session types and the default PDU session type.

The allowed Session and Service Continuity (SSC) modes and the default SSC mode

The allowed SSC modes and the default SSC mode.

QoS Information: the subscribed session-Aggregate Maximum Bit Rate (AMBR), default 5G QoS Indicator (5GI) and default Allocation and Retention Priority (ARP).

The static IP address/prefix.

The subscribed user plane security policy.

The charging characteristics to be associated with the PDU session. Whether this information is provided by the UDM to a SMF in another PLMN (for PDU sessions in Local Break Out (LBO) mode) is defined by operator policies in the UDM/unified data repository (UDR).

An UE that is registered over multiple accesses chooses over which access to establish a PDU session. The home PLMN (HPLMN) may send policies to the UE to guide the selection of the access over which to establish a PDU session.

An UE may request to move a PDU session between 3GPP access and non-3GPP access. The decision to move PDU sessions between the 3GPP access and the non-3GPP access is made on a per PDU session basis. That is, the UE may, at a given time, have some PDU sessions using 3GPP access while other PDU sessions are using non-3GPP access.

In a PDU Session Establishment Request message sent to the network, the UE provides a PDU session identifier. A PDU session identifier (ID) is unique per UE and is an identifier used to uniquely identify one of UE's PDU sessions. The PDU session ID is stored in the UDM to support handover between 3GPP access and non-3GPP access when different PLMNs are used for the two accesses.

The UE may also provide the following information in the PDU Session Establishment Request message:

PDU session type.

S-NSSAI.

Data Network Name (DNN).

SSC mode.

Selective Activation and Deactivation of User Plane (UP) Connection of Existing PDU Session

This is applied when a UE has established multiple PDU sessions. The activation of a UP connection of an existing PDU session causes the activation of its UE-core network (CN) user plane connection (i.e., data radio bearer and N3 tunnel).

For the UE in a connection management (CM)-IDLE state in 3GPP access, either a UE-triggered service request procedure or a network-triggered service request procedure supports independent activation of UP connection of existing PDU session. For the UE in the CM-IDLE state in non-3GPP access, the UE-triggered service request procedure allows the re-activation of UP connection of existing PDU sessions, and may support independent activation of UP connection of existing PDU session.

A UE in a CM-CONNECTED state invokes a service request procedure to request the independent activation of the UP connection of existing PDU sessions.

Network triggered re-activation of UP connection of existing PDU Sessions is handled as follows:

If a CM state of the UE in the AMF is already CM-CONNECTED on the access (3GPP or non-3GPP) associated with the PDU session in the SMF, the network may re-activate the UP connection of a PDU session using a network initiated service request procedure.

Otherwise:

If the UE is registered in both 3GPP access and non-3GPP access and the UE CM state in the AMF is CM-IDLE in non-3GPP access, the UE may be paged or notified through the 3GPP access for a PDU session associated with the 3GPP access or the non-3GPP access in the SMF.

If the UE CM state in the AMF is CM-IDLE in 3GPP access, a paging message may include an access type associated with the PDU session in the SMF. The UE, upon reception of the paging message containing an access type, shall reply to the 5GC via the 3GPP access using a NAS Service Request message, which contains a list of PDU sessions associated with the received access type and whose UP connections can be performed. If the PDU session for which the UE has been paged is in the list of PDU sessions provided in the NAS Service Request, the 5GC re-activates the PDU Session UP connection over 3GPP access;

If the UE CM state in the AMF is CM-CONNECTED in 3GPP access, the notification message may include the non-3GPP access type. The UE, upon reception of the notification message, shall reply to the 5GC via the 3GPP access using the NAS Service Request message which contains a list of allowed PDU sessions or a list of allowed PDUs that can be re-activated over 3GPP. Herein, the NAS Service Request message contains the list of allowed PDU sessions that can be re-activated over 3GPP, or contains an empty list of allowed PDU sessions if no PDU sessions are allowed to be re-activated over 3GPP access.

If the UE is registered in both 3GPP and non-3GPP accesses served by the same AMF, and the UE CM state in the AMF is CM-IDLE in 3GPP access and is in CM-CONNECTED in non 3GPP access, the UE can be notified through the non-3GPP for a PDU session associated in the SMF to the 3GPP access. Upon reception of the notification message, when 3GPP access is available, the UE replies to the 5GC via the 3GPP access using the NAS Service Request message.

The deactivation of the UP connection of an existing PDU session causes the corresponding data radio bearer and N3 tunnel to be deactivated. The UP connections of different PDU Sessions can be deactivated independently when a UE is in CM-CONNECTED state in 3GPP access or non-3GPP access.

Uplink Data Status

A service request in the 5G system is used for ‘CM state transition’ for restoring NAS signaling connection similarly to an existing 3GPP system, and for activation of UP connection for each PDU session not having UP connection (i.e., data radio bearer (DRB) and N3 tunnel between the AN and the UPF).

However, unlike the EPC, if the UE has several PDU sessions, each session can be activated individually (i.e., independently or selectively), or can restore only the NAS signaling connection for signaling (or SMS, etc.) without activation of UP connection. This may be considered to be similar to the operation of the existing UMTS.

In 5GS unlike the existing EPC/LTE system, a method has been adopted, which assigns resources only when activating and using the corresponding PDU session for user plane (UP) context for currently established PDU sessions, i.e., for resources including DRB and N3/NG-U tunnel between a base station (i.e., AN) and the UPF in a radio section (see clause 5.6.8 of 3GPP TS 23.501). Hence, the UE, upon switching from an idle mode to a connected mode, does not request UP context for all the currently established PDU sessions, and requests UP context setup only for PDU sessions that require UP setup due to generation of mobile originated (MO) data. This can be implemented through a method of specifying PDU sessions, that require UP activation, to a Service Request procedure and a Registration procedure (i.e., mobility and periodic registration update), and can be implemented as an information element (IE) called “Uplink Data Status” on 5G NAS. This is described in 3GPP TS 24.501 v1.0.0 as follows.

The purpose of the uplink data status IE is to indicate to the network which preserved PDU session contexts have uplink data pending.

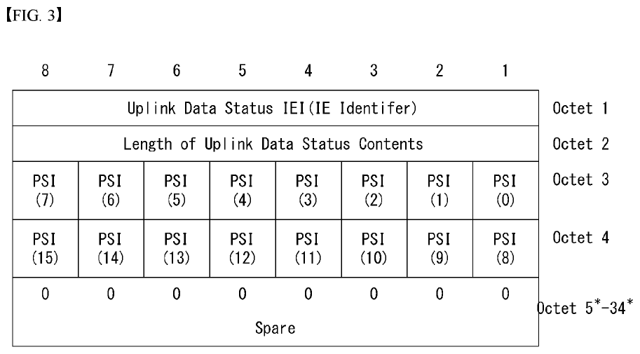

The uplink data status IE is coded as indicated in FIG. 3 and the following Table 1.

The uplink data status IE is a type 4 information element with minimum length of 3 octets to a maximum length of 34 octets.

FIG. 3 illustrates an uplink data status information element in a wireless communication system to which the present disclosure is applicable.

Table 1 illustrates coding of PDU session identity (ID) (PSI) (x) in FIG. 3.

TABLE 1
PSI(x) is coded as follows:
PSI(0) - PSI(4):
Bits 1 to 4 of octet 3 are spare and are coded as zero.
PSI(5) - PSI(15):

| | |
|---|---|
| 0 | indicates that no uplink data is pending for the corresponding |
| | PDU session identity. |
| 1 | indicates that uplink data is pending for the corresponding PDU |
| | session identity. |

All bits in octets 5 to 34 are spare and are coded as zero, if each octet
is included in the information element.

NAS Mobility Management (MM) State Machine of 5G System

In the following description, the 5GS mobility management (5GMM) sublayer of the UE and the network is described. 5GMM sublayer states are independently managed per access type, i.e. 3GPP access or non-3GPP access.

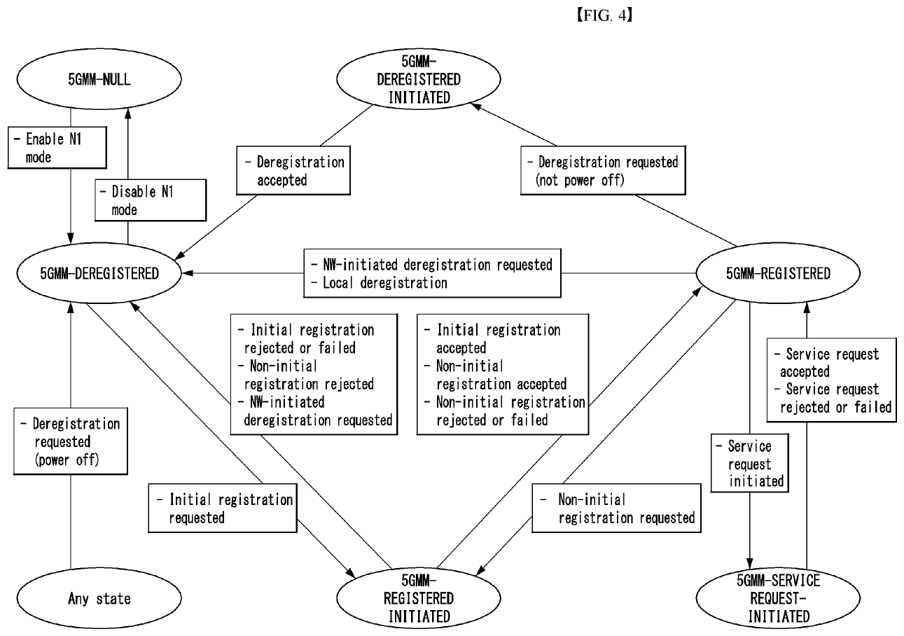

FIG. 4 illustrates a 5GMM sublayer state of a UE in a wireless communication system to which the present disclosure is applicable.

5GMM-NULL

5GS services are disabled in the UE. The 5GS mobility management function is not performed in this state.

5GMM-DEREGISTERED

In the state 5GMM-DEREGISTERED, no 5GMM context has been established, and a UE location is unknown to the network and hence it is unreachable to the UE by a network. In order to establish a 5GMM context, the UE shall start an initial registration procedure.

5GMM-REGISTERED-INITIATED

The UE enters the state 5GMM-REGISTERED-INITIATED after the UE has started the initial registration procedure or a non-initial registration procedure, excluding the periodic registration update over non-3GPP access. And, the UE is waiting for a response from the network.

5GMM-REGISTERED

In the state 5GMM-REGISTERED, a 5GMM context has been established. Additionally, one or more PDU session context(s) may be activated at the UE. The UE may initiate the non-initial registration procedure (including the normal registration update and periodic registration update) and the service request procedure. The UE in the state 5GMM-REGISTERED over non-3GPP access does not initiate the periodic registration update procedure.

5GMM-DEREGISTERED-INITIATED

A UE enters the state 5GMM-DEREGISTERED-INITIATED after the UE has requested release of the 5GMM context by starting the deregistration procedure. And, the UE is waiting for a response from the network.

5GMM-SERVICE-REQUEST-INITIATED

A UE enters the state 5GMM-SERVICE-REQUEST-INITIATED after the UE has started the service request procedure. And, the UE is waiting for a response from the network.

Substrates of the state 5GMM-DEREGISTERED are described below.

The state 5GMM-DEREGISTERED is subdivided into several substrates. The following substrates are not applicable to non-3GPP access:

a) 5GMM-DEREGISTERED.LIMITED-SERVICE

b) 5GMM-DEREGISTERED.PLMN-SEARCH

c) 5GMM-DEREGISTERED.NO-SUPI

d) 5GMM-DEREGISTERED.NO-CELL-AVAILABLE

e) 5GMM-DEREGISTERED.eCALL-INACTIVE

Valid subscriber data are available for the UE before the UE enters the substrates, except for the substrate 5GMM-DEREGISTERED.NO-SUPI.

5GMM-DEREGISTERED.NORMAL-SERVICE

The substrate 5GMM-DEREGISTERED.NORMAL-SERVICE is chosen in the UE when a suitable cell has been found and the PLMN or a tracking area is not in a forbidden list.

5GMM-DEREGISTERED.LIMITED-SERVICE

The substrate 5GMM-DEREGISTERED.LIMITED-SERVICE is chosen in the UE, when a selected cell is unable to provide normal service (e.g., the selected cell is in a forbidden PLMN or is in a forbidden tracking area).

This substrate is not applicable to non-3GPP access.

5GMM-DEREGISTERED.ATTEMPTING-REGISTRATION

The substrate 5GMM-DEREGISTERED.ATTEMPTING-REGISTRATION is chosen in the UE if the initial registration procedure failed due to a missing response from the network.

5GMM-DEREGISTERED.PLMN-SEARCH

The substrate 5GMM-DEREGISTERED.PLMN-SEARCH is chosen in the UE, if the UE is searching for PLMNs. This substrate is left either when a cell has been selected (the new substrate is NORMAL-SERVICE or LIMITED-SERVICE) or when it has been concluded that no cell is available at the moment (the new substrate is NO-CELL-AVAILABLE).

This substrate is not applicable to non-3GPP access.

5GMM-DEREGISTERED.NO-SUPI (SUbscription Permanent Identifie)

The substrate 5GMM-DEREGISTERED.NO-SUPI is chosen in the UE, if the UE has no valid subscriber data available and a cell has been selected.

This substrate is not applicable to non-3GPP access.

5GMM-DEREGISTERED.NO-CELL-AVAILABLE

No 5G cell can be selected. The UE enters this substrate after a first intensive search failed when it is in the substrate 5GMM-DEREGISTERED.PLMN-SEARCH.

This substrate is not applicable to non-3GPP access.

5GMM-DEREGISTERED.eCALL-INACTIVE: This substrate is not applicable to non-3GPP access.

Substrates of the state 5GMM-REGISTERED are described below.

The state 5GMM-REGISTERED is subdivided into several substrates. The following substrates are not applicable to non-3GPP access:

a) 5GMM-REGISTERED.LIMITED-SERVICE

b) 5GMM-REGISTERED.PLMN-SEARCH

c) 5GMM-DEREGISTERED.NON-ALLOWED-SERVICE

d) 5GMM-REGISTERED.NO-CELL-AVAILABLE

5GMM-REGISTERED.NORMAL-SERVICE

The substrate 5GMM-REGISTERED.NORMAL-SERVICE is chosen by the UE as the primary substrate, when the UE enters the state 5GMM-REGISTERED and the cell the UE selected is known to be in an allowed area.

5GMM-REGISTERED.NON-ALLOWED-SERVICE

The substrate 5GMM-REGISTERED.NON-ALLOWED-SERVICE is chosen in the UE, if the cell the UE selected is known to be in a non-allowed area.

This substrate is not applicable to non-3GPP access.

5GMM-REGISTERED.ATTEMPTING-REGISTRATION-UPDATE

The substrate 5GMM-REGISTERED.ATTEMPTING-REGISTRATION-UPDATE is chosen by the UE if the mobility and periodic registration update procedure failed due to a missing response from the network. In this substrate, no 5GMM procedure is initiated by the UE, and no data is transmitted or received, except the followings:

a) mobility and periodic registration update procedure over 3GPP access; and

b) mobility registration procedure over non-3GPP access

5GMM-REGISTERED.LIMITED-SERVICE

The substrate 5GMM-REGISTERED.LIMITED-SERVICE is chosen in the UE, if the cell the UE selected is known not to be able to provide normal service.

This substrate is not applicable to non-3GPP access.

5GMM-REGISTERED.PLMN-SEARCH

The substrate 5GMM-REGISTERED.PLMN-SEARCH is chosen in the UE, while the UE is searching for PLMNs.

This substrate is not applicable to non-3GPP access.

5GMM-REGISTERED.NO-CELL-AVAILABLE

This is a state in which 5G coverage has been lost or a mobile initiated connection only (MICO) mode is active in the UE. If the MICO mode is active, the UE can deactivate the MICO mode at any time by activating the AS layer when the UE needs to send mobile originated signaling or user data. Otherwise, the UE does not initiate any 5GMM procedure except for cell and PLMN reselection.

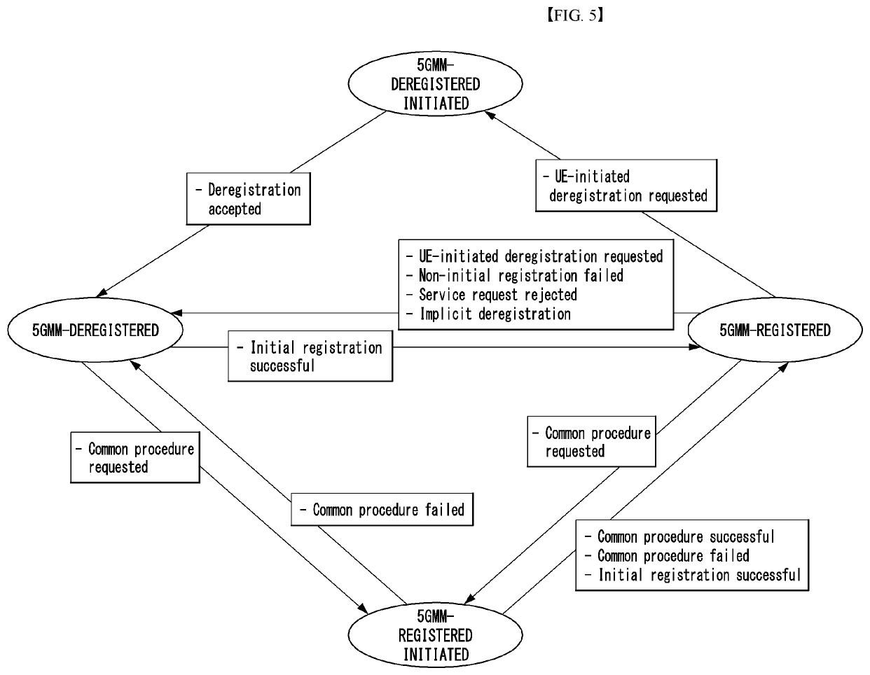

FIG. 5 illustrates a 5GMM sublayer state of a network in a wireless communication system to which the present disclosure is applicable.

5GMM-DEREGISTERED

In the state 5GMM-DEREGISTERED, no 5GMM context has been established or the 5GMM context is marked as deregistered. The UE is deregistered. The network may answer to an initial registration procedure initiated by the UE. The network may also answer to a de-registration procedure initiated by the UE.

5GMM-COMMON-PROCEDURE-INITIATED

The network enters the state 5GMM-COMMON-PROCEDURE-INITIATED after the network has started a common 5GMM procedure, and is waiting for a response from the UE.

5GMM-REGISTERED

In the state 5GMM-REGISTERED, a 5GMM context has been established. Additionally, one or more PDU session context(s) may be activated at the network.

5GMM-DEREGISTERED-INITIATED

The network enters the state 5GMM-DEREGISTERED-INITIATED after the network has started a de-registration procedure, and is waiting for a response from the UE.

In addition to the explanation described above, technologies included in TS 23.501, TS 23.502, TS 23.503, and TS 24.501, TS 24.502, etc., that are stage 2 and stage 3 technical specification (TS) of the 3GPP 5G system, are combined with the following description of the present disclosure and may be considered as the present disclosure.

Handling of Protocol Date Unit (PDU) Session for Low Latency Service

A UE supporting the 5G system can support services with multiple features, and there are defined requirements in which the UE shall particularly support services with very high reliability and ultra-low latency features such as ultra reliable and low latency communication (URLLC).

The UE, in an idle mode or a connected mode, may request user plane (UP) activation for protocol data unit (PDU) session(s) that is in a state in which no UP context is currently generated (or a state in which no UP resource is assigned), i.e., a state in which UP of PDU sessions is deactivated. To this end, this can be implemented through the service request procedure or the registration request procedure in the idle mode, and can also be implemented through the service request procedure in the connected mode.

The 5GMM substrate of the UE (i.e., in the state 5G mobility management (5GMM)-REGISTERED) registered with the 5G system (5GS) is switched to the state 5GMM-SERVICE-REQUEST-INITIATED, if the service request procedure is triggered at a certain time. Until this service request procedure (first service request procedure) is finished, i.e., until the network sends a Service Accept message or a Service Reject message and the service request procedure is completed, the UE remains in this state. In this state, the UE cannot perform a new service request procedure (second service request procedure). If new mobile originated (MO) data occurs during the preceding first service request procedure, and UP connection of PDU session, to which the corresponding data is transmitted, is deactivated, the UE shall wait for the preceding first service request procedure to be completed. And, after the 5GMM state of the UE becomes again the state 5GMM-REGISTERED.NORMAL-SERVICE, the UE can start the second service request procedure for UP activation for a new PDU session.

In the above scenario, if the PDU session, in which MO data occurs, is used by a service requiring low latency feature (e.g., URLLC) during the first service request procedure, there occurs a latency (T1+T2) by adding a latency T1 until the first service request procedure is completed and a time T2 required to complete the second service request procedure from a time at which the UE starts the subsequent second service request procedure.

If ultra low latency feature differentiated from the related art is required, there is a problem in that requirements according to the ultra low latency feature cannot be satisfied by an additional latency of T1 due to the first service request procedure, that has been performed earlier than the second service request procedure, even if a latency for the time T2 satisfies the ultra low latency feature.

To this end, the present disclosure proposes a method of detecting the low latency communication in the SMF.

In the following description, a PDU session for low latency service may mean an always-on PDU session or a low latency PDU session. The PDU session for low latency service means a PDU session, in which the user plane connection for the corresponding PDU session is maintained while the UE is in the connected mode after the user plane connection for the corresponding PDU session is activated.

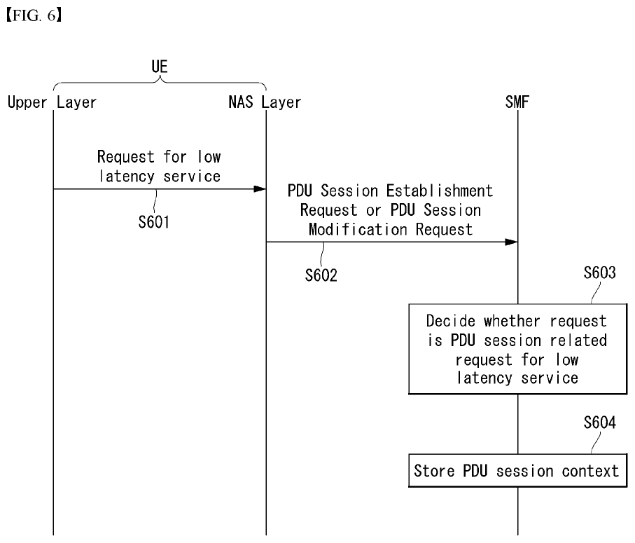

FIG. 6 illustrates a method of controlling a PDU session for low latency service according to an embodiment of the present disclosure.

Referring to FIG. 6, a request for a service with a new low latency feature may be sent from an upper layer (e.g., application) to a NAS layer of a UE in S601.

In this instance, the UE may determine a method of selecting an existing PDU session satisfying quality of service (QoS) of the corresponding service according to a policy within the UE, or a method of modifying a QoS flow of an already established PDU session.

If the UE selects the existing PDU session satisfying the QoS of the corresponding service, a session management (SM) NAS layer of the UE may send a network (e.g., SMF) a PDU session establishment request of a new PDU session in S602.

On the other hand, if the UE modifies the QoS flow of the already established PDU session, the SM NAS layer of the UE may send the network (e.g., SMF) a PDU session modification request for the QoS flow addition/modification of the already established PDU session in S602.

The SMF receiving the request related to PDU session (i.e., PDU Session Establishment Request or PDU Session Modification Request) may decide that a request for the corresponding PDU session is a request for low latency feature (i.e., request related to PDU session for low latency service) in S603.

The SMF may determine whether a request for the corresponding PDU session is a request for low latency feature based on information included in the request related to PDU session (i.e., PDU Session Establishment Request or PDU Session Modification Request). For example, the information included in the request related to PDU session may be one or more of values (e.g., 5G QoS identifier (5QI)) included in requested QoS in the request related to PDU session (i.e., PDU Session Establishment Request or PDU Session Modification Request), a specific data network name (DNN), single network slice selection assistance information (S-NSSAI), and other additional information. For example, the additional information may be information/indication that requests Always on/Low Latency PDU session.

And/or, in order to determine whether a request for the corresponding PDU session is a request for low latency feature, the SMF may check policies through communication with the PCF or check subscriber information of the UE, that sends the corresponding request related to PDU session, through communication with the UDM.

In other words, the SMF may determine whether a request for the corresponding PDU session is a request for low latency feature based on a local policy or configuration, etc. in the SMF and/or based on the information included in the request related to PDU session described above.

The SMF may finally decide that a PDU session established/modified through this procedure is a PDU session capable of supporting low latency service based on these operations.

This decision result may be stored as information (e.g., low latency indicator) of PDU session context managed by the SMF in S604.

For example, the information of the PDU session context may be a simple form of flag of on/off, or a degree of request latency, or a form of relative priority. That is, if the SMF accepts a request for the corresponding low latency feature, the SMF may store information (e.g., low latency indicator) of PDU session context for the established/modified PDU session.

And/or, the SMF may transmit this information (i.e., information that the corresponding PDU session supports low latency) to other network entities according to detailed embodiments to be described later, instead of storing the information of PDU session context. In this case, the step S604 of FIG. 6 may be omitted. That is, if the SMF accepts a request for the corresponding low latency feature, the SMF may transmit, to the AMF or the UE, information that the corresponding PDU session supports the low latency (i.e., low latency information).

### Embodiment 1) AMF Based “Always-On” Connection Handling

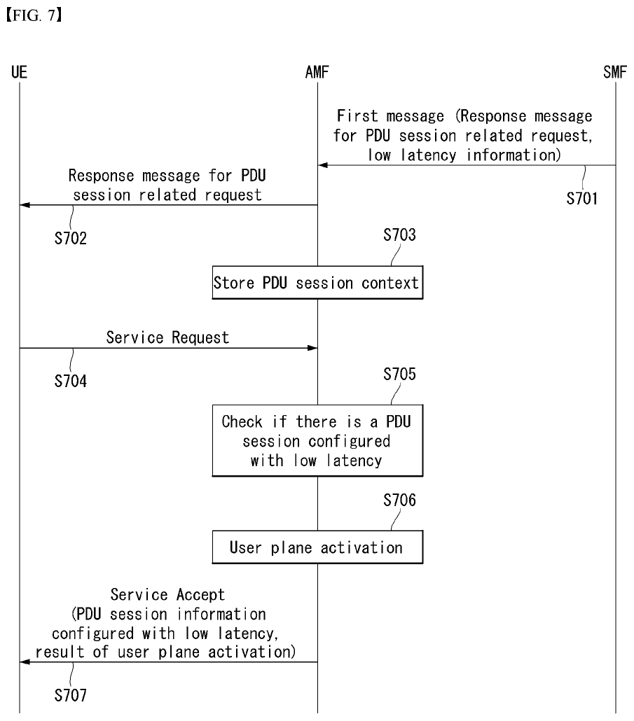

FIG. 7 illustrates a method of controlling a PDU session for low latency service according to an embodiment of the present disclosure.

As described above with reference to FIG. 6, the SMF decides that a PDU session that the UE requests to establish or modify is a PDU session for low latency service.

The SMF sends the AMF this SM message (i.e., PDU Session Establishment Accept or PDU Session Modification Command) using Namf service in an AMF-SMF section, in order to send a response to the SM procedure that the UE requests (i.e., a response to the request related to PDU session) (e.g., PDU Session Establishment Accept or PDU Session Modification Command) in S701.

Here, the message sent from the SMF to the AMF in the AMF-SMF section is referred to as a first message. For example, Namf_Communication_N1N2MessageTransfer request that is the Namf service may correspond to this.

That is, the first message may include a response (i.e., PDU Session Establishment Accept or PDU Session Modification Command) to the request related to PDU session that is sent to the UE and/or N2 SM information to be transmitted to a RAN node.

The SMF may send the first message to the AMF by including information (i.e., low latency information) that the corresponding PDU session shall support the low latency, in the first message, in addition to the above two types of information.

The low latency information may have a format of “Low Latency indication” or “Always on indication”, etc., and may be, for example, one bit flag or binary value.

The AMF receiving this transmits information that shall be transmitted to other node, and handles information that the AMF shall handle. For example, a SM NAS message is included in a N2 message and is sent to the UE in S703, and N2 SM information is also transmitted to the RAN.

The step S703 is simply illustrated so that the AMF sends the UE a response (i.e., PDU Session Establishment Accept or PDU Session Modification Command) to the request related to PDU session, for convenience. More specifically, the response to the request related to PDU session is included in the N2 message and is sent from the AMF to the RAN node, and the response to the corresponding request related to PDU session is encapsulated in the RRC message is sent from the RAN node to the UE.

In this instance, if low latency information, i.e., the low latency indication or the Always on indication is included in the first message, the AMF includes this in corresponding PDU session context information among a context for the corresponding UE. That is, a PDU session context (i.e., each PDU session level context in the UE context) of the UE stored in the AMF may add the following field. Alternatively, the corresponding information may be stored in a memory of the AMF using methods other than the following method.

The following Table 2 illustrate a UE context in the AMF.

TABLE 2

| Field | Description |
|---|---|
| SUPI | Subscription Permanent Identifier |
| | (SUPI) is the subscriber's |
| | permanent identity in 5GS. |
| SUPI- | This indicates whether the SUPI |
| unauthenticated- | is unauthenticated. |
| indicator | |
| Generic Public | The GPSI(s) of the UE. The |
| Subscription | presence is dictated by its |
| Identifier (GPSI) | storage in the UDM. |
| 5G-GUTI | 5G Globally Unique Temporary |
| | Identifier. |
| Permanent Equipment | Mobile Equipment Identity |
| Identifier (PEI) | |
| Internal Group ID- | List of the subscribed internal |
| list | group(s) to which the UE belongs. |
| Specific DRX | UE specific discontinuous |
| Parameters | reception (DRX) parameters. |
| UE Network | Indicates the UE network |
| Capability | capabilities. |
| Events | List of the event subscriptions |
| Subscription | by other control plane (CP) NFs. |
| | Indicating the events being |
| | subscribed as well as any |
| | information on how to send the |
| | corresponding notifications. |
| Access and | Information on AM policy |
| Mobility (AM) | provided by PCF. |
| Policy | |
| Information | |
| PCF ID(s) | The identifier of the PCF for |
| | AM policy. In roaming, the |
| | identifier (ID) of visited PCF |
| | (V-PCF) and the identifier of |
| | optionally home PCF (H-PCF). |
| Subscribed | An index to specific Radio |
| RAT/Frequency | Resource Management (RRM) |
| Selection | configuration in the NG-RAN that |
| Priority (RFSP) | is received from the UDM. |
| Index | |
| RFSP Index in Use | An index to specific RRM |
| | configuration in the NG-RAN that |
| | is currently in use. |
| Mobile Originated | Indicates the MICO Mode for the |
| Communication Only | UE. |
| (MICO) mode | |
| Indication | |
| Voice Support | An indication whether the UE |
| Match Indicator | radio capabilities are compatible |
| | with the network configuration. |
| | The AMF uses it as an input for |
| | setting the IMS voice over |
| | Packet Switched (PS) Session |
| | Supported Indication. |
| UE Radio | Information used by the NG-RAN |
| Capability for | to enhance the paging towards |
| Paging | the UE. |
| Information | |
| Information on | Information sent by the NG-RAN, |
| recommended cells | and used by the AMF when paging |
| and RAN nodes for | the UE to help determining the |
| paging | NG-RAN nodes to be paged as well |
| | as to provide the information on |
| | recommended cells to each of these |
| | NG-RAN nodes, in order to optimize |
| | the probability of successful |
| | paging while minimizing the |
| | signalling load on the radio path. |
| Short Message | The Identifier of the SMSF serving |
| Service Function | the UE in RM-REGISTERED state. |
| (SMSF) Identifier | |
| SMS Supported | Indicates whether the UE supports |
| | SMS delivery over NAS via 3GPP |
| | access, or via non-3GPP access, or |
| | via both the 3GPP and non-3GPP |
| | access. |
| Security Anchor | Master security information |
| Function (SEAF) | received from AUSF |
| data | |

For each access type level context within
the UE access and mobility context:

| | |
|---|---|
| Access Type | Indicates the access type for |
| | this context. |
| Registration | Registration management state. |
| Management (RM) | |
| State | |
| Registration Area | Current Registration Area (a set |
| | of tracking areas in Tracking |
| | Area Identity (TAI) List). |
| TAI of last | TAI of the Tracking Area (TA) in |
| Registration | which the last registration |
| Update | request was initiated. |
| User Location | Information on user location. |
| Information | |
| Mobility | Mobility Restriction(s) restrict |
| Restriction(s) | mobility handling or service |
| | access of a UE in the 5G System. |
| | It consists of RAT restriction, |
| | Forbidden area, Service area |
| | restrictions and Core Network |
| | type restriction. |
| Security | As defined in 3GPP TS 33.501. |
| Information for | |
| Control Plane (CP) | |
| Security | As defined in 3GPP TS 33.501. |
| Information for | |
| User Plane (UP) | |
| Allowed Network | Allowed NSSAI consisting of one |
| Slice Selection | or more S-NSSAIs for serving PLMN |
| Assistance | in the present Registration Area. |
| Information (NSSAI) | |
| Mapping of Allowed | Mapping of Allowed NSSAI is the |
| NSSAI | mapping of each S-NSSAI of the |
| | Allowed NSSAI to the S-NSSAIs of |
| | the Subscribed S-NSSAIs. |
| Network Slice | The Network Slice Instances |
| Instance(s) | selected by 5GC for this UE. |

For each PDU Session level context:

| | |
|---|---|
| S-NSSAI(s) | The S-NSSAI(s) associated to the |
| | PDU Session. |
| DNN | The associated DNN for the PDU |
| | Session. |
| Network Slice | The network Slice Instance |
| Instance ID | information for the PDU Session |
| PDU Session ID | The identifier of the PDU Session. |
| SMF Information | The associated SMF identifier and |
| | SMF address for the PDU |
| | Session. |
| Access Type | The current access type for this |
| | PDU Session. |
| EBI-ARP List | The allocated EBI (EPS Bearer ID) |
| | and associated ARP (Allocation and |
| | Retention Priority) pairs for this |
| | PDU Session. |
| Always on | The indication whether this session |
| indication/Low | needs to be always on or not; or |
| Latency | The indication whether this session |
| indication | should support low latency |
| | communication; |

That is, as illustrated in Table 2, a context for each PDU session is stored in the UE context, and low latency information (e.g., Always on indication/Low Latency indication) may be included in a PDU session context for the corresponding PDU session.

Afterwards, if the UE switches from the idle mode to the connected mode, the UE and the AMF operate as follows.

The UE sends a Service Request to the AMF in the idle mode for the purpose of signaling connection or data transmission in S704.

In the Service Request, user plane (UP) activation for PDU session (i.e., first PDU session) for the above-described low latency service may not be indicated.

The AMF checks context for PDU sessions, that have been currently established, in relation to the Service Request requested by the UE. And, the AMF checks if there is a PDU session configured with the low latency (e.g., configured (set/established) with low latency indication/Always on indication) in S705.

If there is no PDU session configured with the low latency (e.g., configured with low latency indication/Always on indication), the AMF proceeds with the procedure according to the related art operation. More specifically, the AMF performs UP activation for the PDU session included in an uplink data status IE if the uplink data status IE is included in the Service Request message. On the other hand, if the uplink data status IE is not included in the Service Request message, the AMF may maintain only NAS signaling connection or may perform UP activation for the PDU session that is not requested from the UE by the AMF's decision.

In FIG. 7, for convenience of explanation, it is assumed that a PDU session configured with low latency exists among the PDU sessions of UE context that the AMF has stored.

If the PDU session configured with low latency (e.g., configured with low latency indication/Always on indication) exists among the PDU sessions of UE context, that the AMF has currently stored, in the step S705, the AMF performs UP activation for the corresponding PDU session(s) in S706.

This can be applied to all the case in which the PDU session is included or not included in the uplink data status IE in the Service Request message (service type=data), and the case in which the UE does not include the uplink data status IE in the Service Request message (service type=signaling).

If the procedure (UPF adjustment, resource allocation, etc.) required for UP activation is completed, the SMF may send the RAN node and the UE a request for data radio bearer (DRB) setup per PDU session. The AMF may aggregate these requests or immediately send these requests to the RAN node in a First in First out method. In this instance, the AMF may preferentially handle a session configured with the corresponding low latency (e.g., low latency indication/Always on indication).

The AMF sends a Service Accept message to the UE in S707.

In this case, the AMF may include a result of UP activation in the Service Accept message by including the session configured with the low latency (e.g., low latency indication/Always on indication) in the Service Accept message.

In addition, the UE may recognize that the PDU session configured with the low latency has been UP-activated according to the DRB setup before the step S707, or may recognize that the PDU session configured with the low latency has been UP-activated based on the result of UP activation received at the step S707.

After the UP activation is successful as above, the UE maintains the UP connection for the corresponding PDU session while the UE is in the connected mode. If a low latency service starts, the UE may immediately use the low latency service via the PDU session configured with the corresponding low latency without a separate Service Request procedure (since the UP connection is maintained after the UP activation).

### Embodiment 2) UE Based “Always-On” Connection Handling

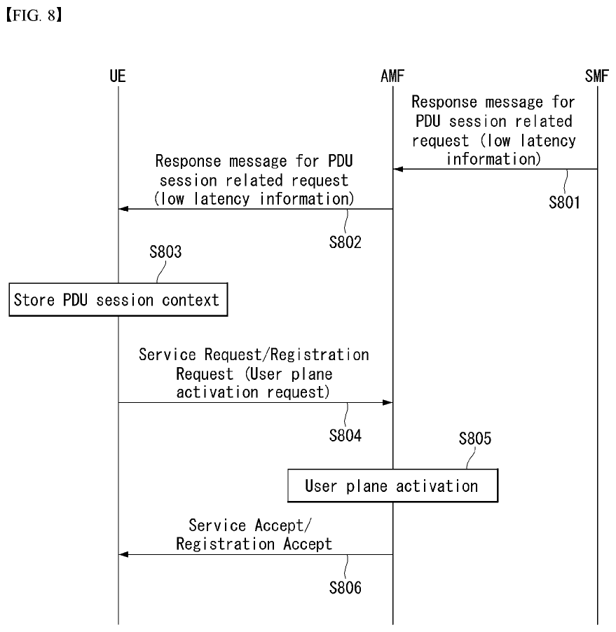

FIG. 8 illustrates a method of controlling a PDU session for low latency service according to an embodiment of the present disclosure.

As described above with reference to FIG. 6, the SMF decides that a PDU session that the UE requests to establish or modify is a PDU session for low latency service.

The SMF sends the UE a response to the SM procedure that the UE previously requests (i.e., a response to the request related to PDU session) (e.g., PDU Session Establishment Accept or PDU Session Modification Command) via the AMF in S801 and S802.

That is, as illustrated in FIG. 7, the SMF sends the first message by including the response to the SM procedure requested by the UE in the first message. The response to the SM procedure requested by the UE includes low latency information. When comparing FIG. 7 and FIG. 8, the low latency information is included in the first message and is transmitted to the AMF in FIG. 7, but the low latency information is included in the response to the SM procedure and is transmitted to the UE in FIG. 8 (i.e., the AMF cannot check this information).

Only when the PDU session establishment/modification request for low latency service from the UE is accepted, the low latency information may be included in the response message. Alternatively, if the PDU session establishment/modification request for low latency service is accepted or rejected, all the low latency information may be included, but its values may be different.

In this instance, the SMF may include information, that the corresponding PDU session shall support low latency (i.e., low latency information/indication), in the response to the SM procedure requested by the UE. That is, the corresponding PDU session corresponds to a PDU session configured with the low latency.

As described above, the low latency information may have a format of “Low Latency indication” or “Always on indication”, etc., and may be, for example, one bit flag or binary value. For example, if the PDU session establishment/modification is accepted, “Low Latency indication” or “Always on indication” IE may be included in the response message, and its value may be set to one. On the other hand, if the PDU session establishment/modification is accepted, “Low Latency indication” or “Always on indication” IE may be included in the response message, and its value may be set to zero. The following Table 3 illustrates PDU SESSION ESTABLISHMENT ACCEPT message contents.

TABLE 3

| IEI | Information | Type/Reference | Presence | Format | Length |
|---|---|---|---|---|---|
| | Extended protocol | Extended protocol | M | V | 1 |
| | discriminator | discriminator 9.2 | | | |
| | PDU session ID | PDU session identity | M | V | 1 |
| | | 9.4 | | | |
| | Procedure | Procedure transaction | M | V | 1 |
| | Transaction | identity 9.6 | | | |
| | Identity (PTI) | | | | |
| | PDU SESSION | Message type 9.7 | M | V | 1 |
| | ESTABLISHMENT | | | | |
| | ACCEPT message | | | | |
| | identity | | | | |
| | Selected PDU | PDU session type | M | V | 1/2 |
| | session type | 9.8.4.6 | | | |
| | Selected Session | SSC mode 9.8.4.10 | M | V | 1/2 |
| | and Service | | | | |
| | Continuity (SSC) | | | | |
| | mode | | | | |
| | DNN | DNN 9.8.3.15 | M | LV | 2-TBD |
| | Authorized QoS | QoS rules 9.8.4.7 | M | LV-E | 2-65537 |
| | rules | | | | |
| | Session Aggregate | Session-AMBR 9.8.4.8 | M | LV | TBD |
| | Maximum Bit Rate | | | | |
| | (AMBR) | | | | |
| 73 | 5G Session | 5GSM cause 9.8.4.2 | O | TV | 2 |
| | Management (5GSM) | | | | |
| | cause | | | | |
| 29 | PDU address | PDU address 9.8.4.5 | O | TLV | 7 |
| 74 | Reflective QoS | GPRS timer 9.8.4.4 | O | TV | 2 |
| | (RQ) timer value | | | | |
| 22 | S-NSSAI | S-NSSAI 9.8.3.45 | O | TLV | 3-10 |
| 78 | EAP message | EAP message 9.8.3.16 | O | TLV-E | 7-1503 |
| 7B | Extended protocol | Extended protocol | O | TLV-E | 4-65538 |
| | configuration | configuration | | | |
| | options | options 9.8.4.3 | | | |
| | Low Latency | | O | TV | 2 |
| | Indication or Always | | | | |
| | on indication | | | | |

In Table 3, ‘IEI’ denotes an information element identifier.

As illustrated in Table 3, low latency information (e.g., Always on indication/Low Latency indication) may be included in the PDU SESSION ESTABLISHMENT ACCEPT message.

The following Table 4 illustrates PDU SESSION MODIFICATION COMMAND message contents.

TABLE 4

| IEI | Information | Type/Reference | Presence | Format | Length |
|---|---|---|---|---|---|
| | Extended protocol | Extended | M | V | 1 |
| | discriminator | protocol | | | |
| | | discriminator | | | |
| | | 9.2 | | | |
| | PDU Session ID | PDU session | M | V | 1 |
| | | identity 9.4 | | | |
| | PTI | Procedure | M | V | 1 |
| | | transaction | | | |
| | | identity 9.6 | | | |
| | PDU SESSION | Message type | M | V | 1 |
| | MODIFICATION | 9.7 | | | |
| | COMMAND | | | | |
| | message identity | | | | |
| 73 | 5GSM cause | 5GSM cause | O | TV | 2 |
| | | 9.8.4.2 | | | |
| 2A | Session AMBR | Session-AMBR | O | TLV | 8 |
| | | 9.8.4.8 | | | |
| 74 | RQ timer value | GPRS timer | O | TV | 2 |
| | | 9.8.4.3 | | | |
| 7B | Authorized QoS | QoS rules | O | TLV-E | 3-65538 |
| | rules | 9.8.4.7 | | | |
| 7B | Extended protocol | Extended | O | TLV-E | 4-65538 |
| | configuration | protocol | | | |
| | options | configuration | | | |
| | | options 9.8.4.3 | | | |
| | Low Latency | | O | TV | 2 |
| | indication or | | | | |
| | Always on | | | | |
| | indication | | | | |

In Table 4, ‘IEI’ denotes an information element identifier.

As illustrated in Table 4, low latency information (e.g., Always on indication/Low Latency indication) may be included in the PDU SESSION MODIFICATION COMMAND message.

If the low latency information is included in the received SM response message (e.g., PDU SESSION ESTABLISHMENT ACCEPT message or PDU SESSION MODIFICATION COMMAND message), the NAS layer of the UE stores it in the corresponding PDU session context in S803.

Afterwards, if the UE switches from the idle mode to the connected mode, the UE and the AMF operate as follows.

If the Service Request procedure or the Registration procedure starts for the purpose of signaling connection or data transmission, the UE shall request UP activation for the PDU session configured with the low latency in S804.

This corresponds to both the case in which mobile originated (MO) data for the PDU session configured with the low latency occurs, and the case in which the MO data does not occur.

That is, the UE includes an uplink data status IE in the Service Request message or the Registration Request message and requests the UP activation for the PDU session configured with the low latency within the corresponding uplink data status IE.

The AMF performs the UP activation for PDU session(s) configured with the corresponding low latency in S805.

If the procedure (UPF adjustment, resource allocation, etc.) required for the UP activation is completed, the SMF may send the RAN node and the UE a request for data radio bearer (DRB) setup per PDU session. The AMF may aggregate these requests or immediately send these requests to the RAN node in a First in First out method. In this instance, the AMF may preferentially handle a session configured with the corresponding low latency (e.g., low latency indication/Always on indication).

The AMF sends the UE the Service Accept message if the Service Request is accepted, or the AMF sends the UE the Registration Accept message if the Registration Request is accepted, in S806.

After the UP activation is successful as above, the UE maintains the UP connection for the corresponding PDU session while the UE is in the connected mode. If a low latency service starts, the UE may immediately use the low latency service via the PDU session configured with the corresponding low latency without a separate Service Request procedure (since the UP connection is maintained after the UP activation).

Overview of Device to which the Present Disclosure is Applicable

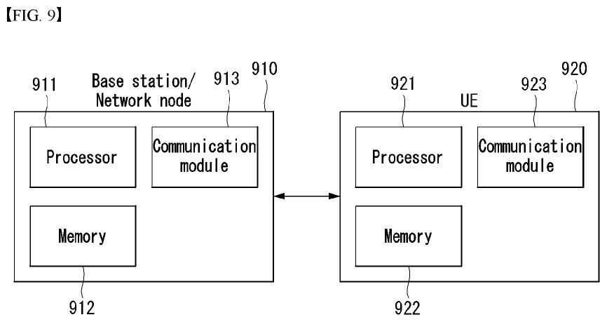

FIG. 9 illustrates a block configuration diagram of a communication device according to an embodiment of the present disclosure.

Referring to FIG. 9, a wireless communication system includes a network node 910 and a plurality of UEs 920.

The network node 910 includes a processor 911, a memory 912, and a transceiver 913. The processor 911 implements functions, processes, and/or methods proposed in FIGS. 1 to 8. Layers of wired/wireless interface protocol may be implemented by the processor 911.

The memory 912 is connected to the processor 911 and stores various types of information for driving the processor 911. The transceiver 913 is connected to the processor 911 and transmits and/or receives wired/wireless signals. Examples of the network node 910 may include a base station (eNB, ng-eNB and/or gNB), MME, AMF, SMF, HSS, SGW, PGW, SCEF, SCS/AS, and the like. In particular, when the network node 910 is the base station (eNB, ng-eNB and/or gNB), the transceiver 913 may include a radio frequency (RF) unit for transmitting/receiving a radio signal.

The UE 920 includes a processor 921, a memory 922, and a transceiver (or RF unit) 923. The processor 921 implements functions, processes, and/or methods proposed in FIGS. 1 to 8. Layers of a radio interface protocol may be implemented by the processor 921. In particular, the processor may include a NAS layer and an AS layer. The memory 922 is connected to the processor 921 and stores various types of information for driving the processor 921. The transceiver 923 is connected to the processor 921 and transmits and/or receives a radio signal.

The memories 912 and 922 may be inside or outside the processors 911 and 921 and may be connected to the processors 911 and 921 through various well-known means. Further, the network node 910 (in case of the base station) and/or the UE 920 may have a single antenna or multiple antennas.

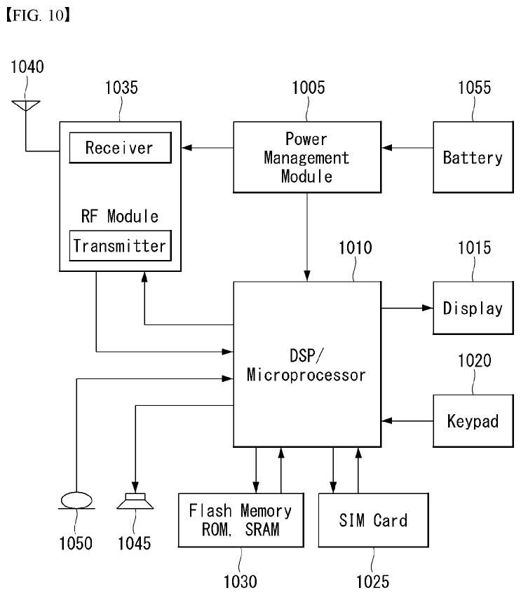

FIG. 10 illustrates a block configuration diagram of a communication device according to an embodiment of the present disclosure.

In particular, FIG. 10 illustrates in more detail the UE illustrated in FIG. 9.

Referring to FIG. 10, the UE may include a processor (or digital signal processor (DSP)) 1010, an RF module (or RF unit) 1035, a power management module 1005, an antenna 1040, a battery 1055, a display 1015, a keypad 1020, a memory 1030, a subscriber identification module (SIM) card 1025 (which is optional), a speaker 1045, and a microphone 1050. The UE may also include a single antenna or multiple antennas.

The processor 1010 implements functions, processes, and/or methods described in FIGS. 1 to 8. Layers of a radio interface protocol may be implemented by the processor 1010.

The memory 1030 is connected to the processor 1010 and stores information related to operations of the processor 1010. The memory 1030 may be inside or outside the processor 1010 and may be connected to the processors 1010 through various well-known means.

A user inputs instructional information, such as a telephone number, for example, by pushing (or touching) buttons of the keypad 1020 or by voice activation using the microphone 1050. The processor 1010 receives and processes the instructional information to perform an appropriate function, such as to dial the telephone number. Operational data may be extracted from the SIM card 1025 or the memory 1030. Further, the processor 1010 may display instructional information or operational information on the display 1015 for the user's reference and convenience.

The RF module 1035 is connected to the processor 1010 and transmits and/or receives a RF signal. The processor 1010 sends instructional information to the RF module 1035 in order to initiate communication, for example, transmit a radio signal configuring voice communication data. The RF module 1035 consists of a receiver and a transmitter to receive and transmit the radio signal. The antenna 1040 functions to transmit and receive the radio signal. Upon reception of the radio signal, the RF module 1035 may send a signal to be processed by the processor 1010 and convert the signal into a baseband. The processed signal may be converted into audible or readable information output via the speaker 1045.

The aforementioned embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. Software code may be stored in a memory unit and executed by a processor. The memory unit may be located at the interior or exterior of the processor and may transmit data to and receive data from the processor via various known means.

It is apparent to those skilled in the art that the present disclosure can be embodied in other specific forms without departing from essential features of the present disclosure. Accordingly, the aforementioned detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

### INDUSTRIAL APPLICABILITY

The present disclosure has been described focusing on examples applying to the 3GPP LTE/LTE-A system or a 5th generation (5G) system, but can be applied to various wireless communication systems other than them.

1. A method for a session management function (SMF) to control a protocol data unit (PDU) session for a low latency service in a wireless communication system, the method comprising:
receiving, from a user equipment (UE), a request message related to the PDU session;
determining whether the request message related to the PDU session is a request for the low latency service; and
sending the UE a response message for the request message related to the PDU session based on the request message related to the PDU session including the request for the low latency service, the response message including low latency information for a PDU session related to the request message related to the PDU session.

2. The method of claim 1, wherein it is determined whether the request message related to the PDU session is the request for the low latency service based on a fifth generation (5G) quality of service (QoS) identifier (5QI), a data network name (DNN), single network slice selection assistance information (S-NSSAI), or an indication that requests the PDU session for the low latency service, that are included in the request message related to the PDU session.

3. The method of claim 1, wherein it is determined whether the request message related to the PDU session is the request for the low latency service by checking a policy through a communication with a policy control function (PCF) or checking subscriber information of the UE through a communication with a unified data management (UDM).

4. The method of claim 1, wherein the request message related to the PDU session is a PDU session establishment request or a PDU session modification request.

5. The method of claim 1, wherein the response message is a PDU session establishment accept message or a PDU session modification command message.

6. The method of claim 1, further comprising storing low latency information in a PDU session context for the PDU session related to the request message related to the PDU session.

7. The method of claim 1, wherein the PDU session for the low latency service includes an always-on PDU session or a low latency PDU session.

8. The method of claim 7, wherein the PDU session for the low latency service is a PDU session in which a user plane connection for the PDU session for the low latency service is maintained while the UE is in a connected mode after the user plane connection for the PDU session for the low latency service is activated.

9. A session management function (SMF) device for controlling a protocol data unit (PDU) session for a low latency service in a wireless communication system, the SMF device comprising:
a transceiver configured to transmit and receive a radio signal; and
a processor configured to control the transceiver,
wherein the processor is further configured to:
receive, from a user equipment (UE), a request message related to the PDU session;
determine whether the request message related to the PDU session is a request for the low latency service; and
send the UE a response message for the request message related to the PDU session based on the request message related to the PDU session including the request for the low latency service, the response message including low latency information for a PDU session related to the request message related to the PDU session.

10. The SMF device of claim 9, wherein it is determined whether the request message related to the PDU session is the request for the low latency service based on a fifth generation (5G) quality of service (QoS) identifier (5QI), a data network name (DNN), single network slice selection assistance information (S-NSSAI), or an indication that requests the PDU session for the low latency service, that are included in the request message related to the PDU session.

11. The SMF device of claim 9, wherein it is determined whether the request message related to the PDU session is the request for the low latency service by checking a policy through a communication with a policy control function (PCF) or checking subscriber information of the UE through a communication with a unified data management (UDM).

12. The SMF device of claim 9, wherein the request message related to the PDU session is a PDU session establishment request or a PDU session modification request.

13. The SMF device of claim 9, wherein the response message is a PDU session establishment accept message or a PDU session modification command message.

14. The SMF device of claim 9, wherein low latency information is stored in a PDU session context for the PDU session related to the request message related to the PDU session.
